(19) United States
(12) Patent Application Publication
(10) Pub. No.: US 2016/0144875 A1
(43) Pub. Date: May 26, 2016

(54) APPARATUS AND METHOD FOR DISTRIBUTED PROCESSING OF TRAIN MONITORING TRAFFIC BASED ON HIERARCHICAL WIRELESS SENSOR NETWORK

(71) Applicant: Electronics and Telecommunications Research Institute, Daejeon (KR)

(72) Inventors: Young Il KIM, Daejeon (KR); Won RYU, Seoul (KR); Dae Geun PARK, Daejeon (KR); Geon Min YEO, Daejeon (KR); Yong Tae LEE, Daejeon (KR); Sun Hwa LIM, Daejeon (KR)

(21) Appl. No.: 14/949,641

(22) Filed: Nov. 23, 2015

(30) Foreign Application Priority Data
Nov. 24, 2014 (KR) 10-2014-0164732
Oct. 16, 2015 (KR) 10-2015-0145003

(51) Int. Cl. B61L 25/02; H04W 24/10

(52) U.S. Cl. CPC B61L 25/026; H04W 24/10; B61L 25/021; H04W 84/18

(57) ABSTRACT

Provided is an apparatus for distributed processing of train monitoring traffic based on a hierarchical wireless sensor network, the apparatus including: a wireless sensor node configured to generate sensor data by measuring states of a train; a wireless mesh network (WSN) manager configured to classify the sensor data into priority data and non-priority data according to change characteristics, and to transmit the priority data to a sensor monitoring center through a wireless communication network and the non-priority data to wireless mesh nodes through a wireless mesh network; and one or more wireless mesh nodes configured to be spaced apart at predetermined intervals on a railway side, and to transmit the non-priority data, received from the WSN manager, to the sensor monitoring center.

### CROSS-REFERENCE TO RELATED APPLICATION(S)

This application claims priority from Korean Patent Application Nos. 10-2014-0164732, filed on Nov. 24, 2014 and 10-2015-0145003, filed on Oct. 16, 2015, in the Korean Intellectual Property Office, the entire disclosures of which are incorporated herein by references for all purposes.

### BACKGROUND

1. Field

The following description generally relates to a wireless sensor network that measures train operating states for safe train operation, and more particularly to distributed processing of traffic in a wireless sensor network that measures train operating states.

2. Description of the Related Art

For safe train operation, abnormalities of a train may be checked by measuring its operating states, in which heating and vibration of the train axel are detected in real time so that when a failure occurs, the train may be immediately repaired. The general method of measuring train operating states includes installing on a railroad a device for measuring temperature of a railway vehicle bogie in a contactless manner, and transmitting measured temperature to a maintenance center through a wired communication network. However, such method may not be performed appropriately due to limited accuracy and limited number of measurements, and thus accidents, such as derailing trains, may not be prevented, which significantly affects safe train operation. Accordingly, there is a need for a technique for measuring train operating states in real time and transmitting measured data to a control center through a wireless communication network.

The aforesaid method includes measuring in real time temperature and vibration of the axle of a railway vehicle bogie; and periodically transmitting measured data through a wireless sensor network by utilizing low power wireless communication technology. However, such method has drawbacks in that when a huge amount of measured data, obtained in real time from wireless sensors installed on a railway vehicle bogie, are transmitted through a wireless sensor network and a mobile network, a bottleneck situation may occur due to limited capacity of the wireless sensor network, thereby disrupting smooth operations. Korean Patent No. 10-0877587 discloses a method of detecting vibration during operation of a high-speed train and a location of the vibration, and transmitting the detected vibration and the location thereof to a control center. However, such method, which merely transmits information detected through a wireless communication network, fails to provide a solution to the issue of traffic.

### SUMMARY

Provided is an apparatus and method for distributed processing of train monitoring traffic based on a hierarchical wireless sensor network, which may prevent a traffic bottleneck of sensor data generated in real time by receiving train operating states in real time through a wireless sensor network, thereby enabling safe train operation.

In one general aspect, there is provided an apparatus for distributed processing of train monitoring traffic based on a hierarchical wireless sensor network, the apparatus including: a wireless sensor node configured to generate sensor data by measuring states of a train; a wireless mesh network (WSN) manager configured to classify the sensor data into priority data and non-priority data according to change characteristics, and to transmit the priority data to a sensor monitoring center through a wireless communication network and the non-priority data to wireless mesh nodes through a wireless mesh network; and one or more wireless mesh nodes configured to be spaced apart at predetermined intervals on a railway side, and to transmit the non-priority data, received from the WSN manager, to the sensor monitoring center.

The WSN manager may establish a wireless sensor network inside the train, and may be connected with an adjacent wireless mesh node to form a wireless mesh network. The WSN manager may calculate the change characteristics based on means and variances of the sensor data, and may classify frequently-changed sensor data as the priority data and less frequently changed data as the non-priority data.

The WSN manager may determine whether the train approaches the one or more wireless mesh nodes based on location information of the train and location information of the one or more wireless mesh nodes. To this end, the WSN may identify the one or more wireless mesh nodes located in a proceeding direction of the train based on the location information of the wireless mesh nodes and the location information of the train, may calculate a wireless mesh node which is closest to the train among the identified wireless mesh nodes, and may estimate a time at which the train arrives at the closest wireless mesh node by considering a distance from the calculated wireless mesh node and a moving speed of the train, so as to form the wireless mesh network with the calculated wireless mesh node. Further, the WSN manager may input a time information index, including measurement time information of the sensor data, into the priority data and the non-priority data. The wireless sensor node may periodically measure temperature and vibration on an axle of a railway vehicle bogie.

In another general aspect, there is provided a method of distributed processing of train monitoring traffic based on a hierarchical wireless sensor network, the method including: generating sensor data by periodically measuring states of a train; classifying the sensor data into priority data and non-priority data by assigning priorities according to change characteristics; transmitting the priority data to a sensor monitoring center through a wireless communication network; and transmitting the non-priority data to wireless mesh nodes through a wireless mesh network. In this manner, distributed processing of train monitoring traffic may be performed through a hierarchical wireless sensor network.

The classifying into the priority data and the non-priority data may include: calculating the change characteristics based on means and variances of the sensor data; classifying frequently-changed sensor data as the priority data; and classifying less frequently changed data as the non-priority data.

The method may further include determining whether the train approaches the wireless mesh nodes based on location information of the train and location information of the one or more wireless mesh node. The determining whether the train approaches the wireless mesh nodes may include: identifying the wireless mesh nodes located in a proceeding direction of the train based on the location information of the wireless mesh nodes and the location information of the train; calculating a wireless mesh node which is closest to the train among the identified wireless mesh nodes; and estimating a time at which the train arrives at the closest wireless mesh node by considering a distance from the calculated wireless mesh node and a moving speed of the train.

### BRIEF DESCRIPTION OF THE DRAWINGS

FIGS. 1A and 1B are diagrams illustrating an apparatus 100 for distributed processing of train monitoring traffic based on a hierarchical wireless sensor network according to an exemplary embodiment.

FIG. 2 is a detailed diagram illustrating Wireless Sensor Network (WSN) Access Point (AP) 240 of the apparatus 100 for distributed processing of train monitoring traffic based on a hierarchical wireless sensor network according to an exemplary embodiment.

FIG. 3 is a flowchart illustrating distributed processing of train monitoring traffic which is performed by using the apparatus 100 for distributed processing of train monitoring traffic based on a hierarchical wireless sensor network according to an exemplary embodiment.

FIG. 4 is a flowchart illustrating connection to a mesh network by using the apparatus 100 for distributed processing of train monitoring traffic based on a hierarchical wireless sensor network according to an exemplary embodiment.

FIG. 5 is a flowchart illustrating a method of distributed processing performed by using the apparatus 100 for distributed processing of train monitoring traffic based on a hierarchical wireless sensor network according to an exemplary embodiment.

FIG. 6 is a flowchart illustrating a method of interworking with a mesh network by using the apparatus 100 for distributed processing 100 of train monitoring traffic based on a hierarchical wireless sensor network according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, the multi-angle view processing apparatus will be described in detail with reference to the accompanying drawings. The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Further, the terms used herein are defined in consideration of the functions of elements in the following embodiments, and can be changed according to the intentions or the customs of a user and an operator. Accordingly, the terms used in the following embodiments conform to the definitions described specifically in the present disclosure, and if there are no specific definitions, the terms should be interpreted as having the same meaning as commonly understood by one of ordinary skill in the art to which this invention pertains.

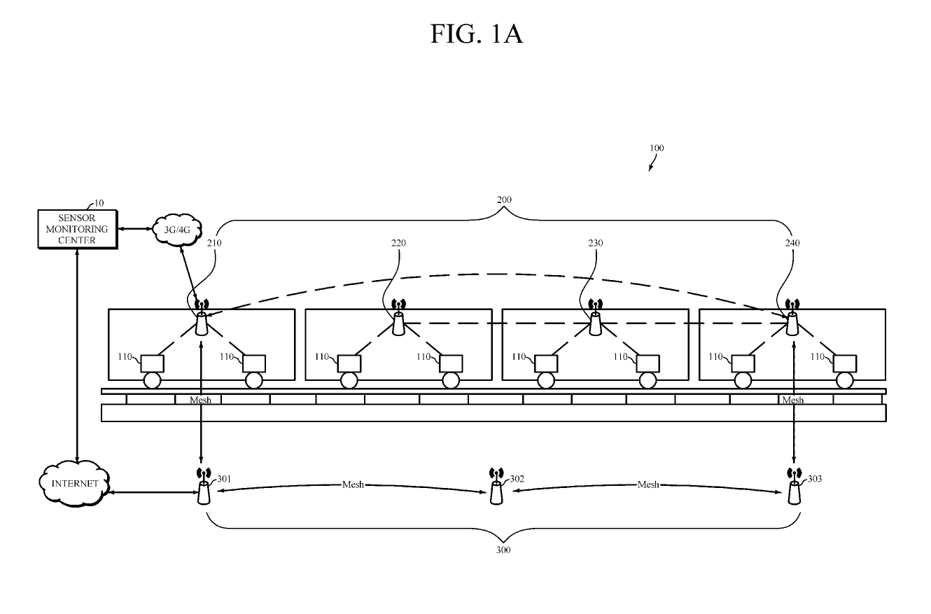

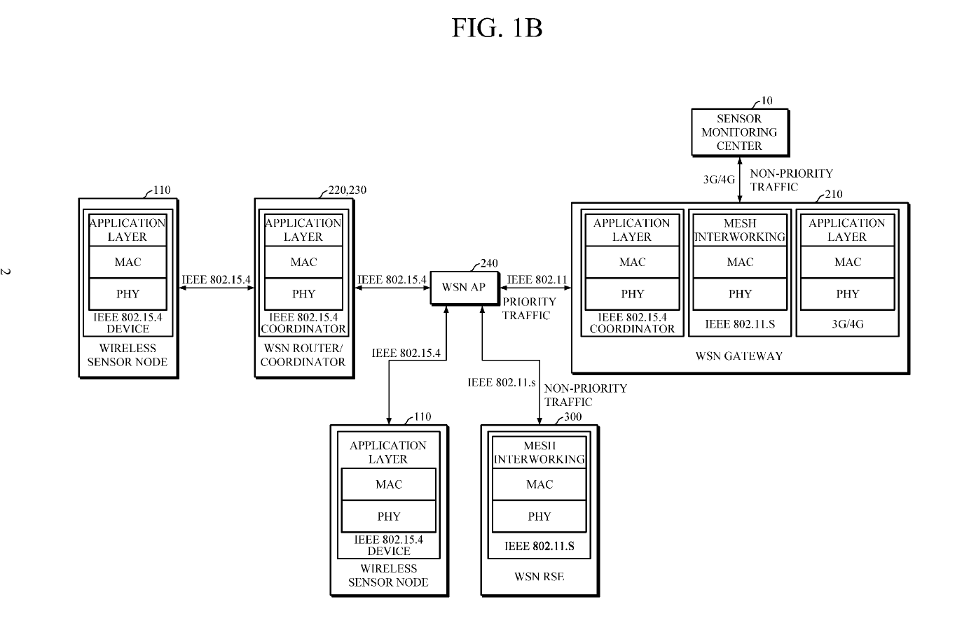

FIGS. 1A and 1B are diagrams illustrating an apparatus 100 for distributed processing of train monitoring traffic based on a hierarchical wireless sensor network according to an exemplary embodiment.

Referring to FIGS. 1A and 1B, the apparatus 100 for distributed processing of train monitoring traffic based on a hierarchical wireless sensor network periodically monitors train operating states, classifies sensor data of the monitoring results into priority data and non-priority data according to change characteristics, and transmits the classified data by using different communication methods, thereby enabling distributed processing of train monitoring traffic.

The apparatus 100 for distributed processing of train monitoring traffic has a Wireless Sensor Network (WSN) inside the train, and collects sensor data by periodically measuring temperature and vibration of bearings mounted on the axle of a railway vehicle bogie. Further, the apparatus 100 for distributed processing of train monitoring traffic assigns priorities to measured sensor data according to change characteristics, classifies the sensor data into of high priority signals and low priority signals, and transmits the classified signals to a sensor monitoring center 10 through different transmission paths. The sensor monitoring center 10 may include a component that commands and controls operations of trains or monitors operating states of trains.

The apparatus 100 for distributed processing of train monitoring traffic transmits frequently-changed priority data to the sensor monitoring center 10 through a mobile communication network, and transmits, through a mesh link, less frequently changed data to wireless mesh nodes 300 arranged at predetermined intervals on the railway side (on the periphery of a railroad). In this manner, traffic of periodically measured sensor data may be distributed, thereby preventing a traffic bottleneck situation.

The apparatus 100 for distributed processing of train monitoring traffic based on a hierarchical wireless sensor network includes one or more wireless sensor nodes 110, a WSN manager 200, and one or more wireless mesh nodes 300. The WSN manager 200 and the wireless sensor nodes 110 form a wireless sensor network (WSN). The WSN manager 200 and the one or more wireless mesh nodes 300 form a mesh network through a wireless mesh link. Hereinafter, for convenience of explanation, the apparatus 100 for distributed processing of train monitoring traffic based on a hierarchical wireless sensor network will be referred to as the apparatus 100 for distributed processing of train monitoring traffic.

The wireless sensor nodes 110 include a plurality of sensors to measure temperature and vibration, and periodically measures temperature and vibration of bearings mounted on the axle of a railway vehicle bogie. Further, the wireless sensor nodes 110 transmit detected sensor data (train state information) to any connected module among a WSN gateway 210, a WSN coordinator 220, a WSN router 230, and a WSN AP 240, which form the WSN manager 200. The wireless sensor nodes 110 may be configured to be connected to any one module regardless of whether the wireless sensor nodes 110 and the WSN manager 200 are located in the same compartment of a train. Communications between the wireless sensor nodes 110 and other modules 210, 220, and 230 may be made through a wireless sensor network, such as ZigBee communications, based on IEEE 802.15.4 standard which is a low-power, low-speed, and near-field wireless communication standard.

The WSN manager 200 includes the WSN gateway 210, one or more WSN coordinators 220, one or more WSN routers 230, and one or more WSN APs 240. The WSN manager 200 may form a single wireless sensor network through a plurality of wireless sensor nodes 110.

The WSN coordinator 220, the WSN router 230, and the WSN AP 240 may vary in number depending on the size (the number of compartments), communication status, and the shape of a train where the WSN coordinator 220, the WSN router 230, and the WSN AP 240 are mounted.

The WSN gateway 210, the WSN coordinator 220, the WSN router 230, and the WSN AP 240, which form the WSN manager 200, may receive sensor data, including state information of a train, by interworking with a connected wireless sensor node 110. Further, the WSN coordinator 220 may transmit sensor data to the WSN gateway 210 via the WSN router 230 and the WSN AP 240 which are in a different hierarchy. The WSN coordinator 220, the WSN router 230, and the WSN AP 240 may communicate with each other through a wireless sensor network (IEEE 802.15.4).

The WSN router 230 may interwork with the connected wireless sensor node 110 to receive sensor data that include train state information. The train state information includes information periodically collected on the temperature and vibration of bearings mounted on the axle of a railway vehicle bogie. Further, the WSN router 230 relays sensor data from the WSN coordinator 220 to the WSN AP 240.

The WSN AP 240 receives sensor data, including train state information, from the connected wireless sensor node 110, the WSN coordinator 220, and the WSN router 230. Further, the WSN AP 240 assigns priorities to the received sensor data according to change characteristics, and classifies the sensor data into high priority signals and low priority signals. Based on change characteristics calculated by analyzing means and variances of the received sensor data, the WSN AP 240 assigns low priority to less frequently changed data and classifies the data as non-priority data, and assigns high priority to more frequently changed data and classifies the data as priority data.

The WSN AP 240 transmits the frequently-changed priority data to the WSN gateway 210 included in a wireless sensor network. The WSN AP 240 and the WSN gateway 210 may communicate with each other by using a wireless LAN standard (IEEE 802.11) such as Wi-Fi.

The WSN gateway 210 transmits the priority data, received from the WSN AP 240, to the sensor monitoring center 10. In this manner, the WSN gateway 210 connects the apparatus 100 for distributed processing of train monitoring traffic, which forms the wireless sensor network, and the sensor monitoring center 10. The WSN gateway 210 and the sensor monitoring center 10 may be communicate with each other by using a mobile communication network such as 3G or 4G. Further, the WSN gateway 210 may directly interwork with the wireless sensor node 110 to receive sensor data, and functions of the WSN coordinator 220, a wireless mesh, and a mobile communication network are integrated in the WSN gateway 210, so that the WSN gateway 210 may interwork with the wireless sensor node 110, the wireless mesh node 300, and the mobile communication network. The WSN gateway 210 may perform the same functions as the WSN AP 240. As illustrated in FIG. 1B, the WSN gateway 210 performs all the functions of the WSN network routing application layer 241 of the WSN AP 240 through the WSN network/mobile network routing application layer 211, and may perform distribution of sensor data and packet processing.

The WSN AP 240 transmits, to the wireless mesh node 300, the non-priority data that has relatively low priority as compared to the priority data. The WSN AP 240 and the wireless mesh node 300 may form a mesh network. Communications between the WSN AP 240 and the wireless mesh node 300 and communications between two or more wireless mesh nodes 300 may be made through a mesh link. The mesh link, which connects the WSN AP 240 and the wireless mesh node 300, may be established based on a mesh network wireless LAN standard, IEEE 802.11.s.

The wireless mesh nodes 300 are arranged at predetermined intervals on the periphery of a railroad on which trains travel, to form a mesh network with the WSN manager 100. The wireless mesh nodes 300 are connected with the WSN gateway 210 and the WSN AP 240 through a mesh link. Once the non-priority data is received from the WSN AP 240 through the mesh link, the wireless mesh nodes 300 transmit the received non-priority data to the sensor monitoring center 10. The wireless mesh network is formed between different wireless mesh nodes 300, such that the non-priority data may be transmitted to the sensor monitoring center 10 through the connection between the wireless mesh nodes 300. The wireless mesh nodes 300 may transmit the non-priority data to the sensor monitoring center 10 through a wired network. Such wireless mesh nodes 300 may be referred to as Wireless Sensor Network Rail Side Equipment (WSN RSE).

The apparatus 100 for distributed processing of train monitoring traffic based on a hierarchical wireless sensor network forms a mesh network by establishing a wireless sensor network inside the train, as well as by connecting the wireless mesh nodes 300 installed on the railway side with the wireless sensor network inside the train. The apparatus 100 for distributed processing of train monitoring traffic classifies sensor data measured in the train into priority data and non-priority data by assigning different priorities according to change characteristics, and directly transmits the priority data from the wireless sensor network to the sensor monitoring center 10 through a mobile communication network. Further, the apparatus 100 for distributed processing of train monitoring traffic may transmit the non-priority data to the sensor monitoring center 10 through the mesh network via the wireless mesh nodes 300 arranged on the railway side.

The general train monitoring method may cause a bottleneck situation due to a huge amount of traffic during transmission of sensor data monitored in real time. By contrast, the present disclosure may prevent such bottleneck of traffic by distributed processing of sensor data, including train state information, in a hierarchical manner.

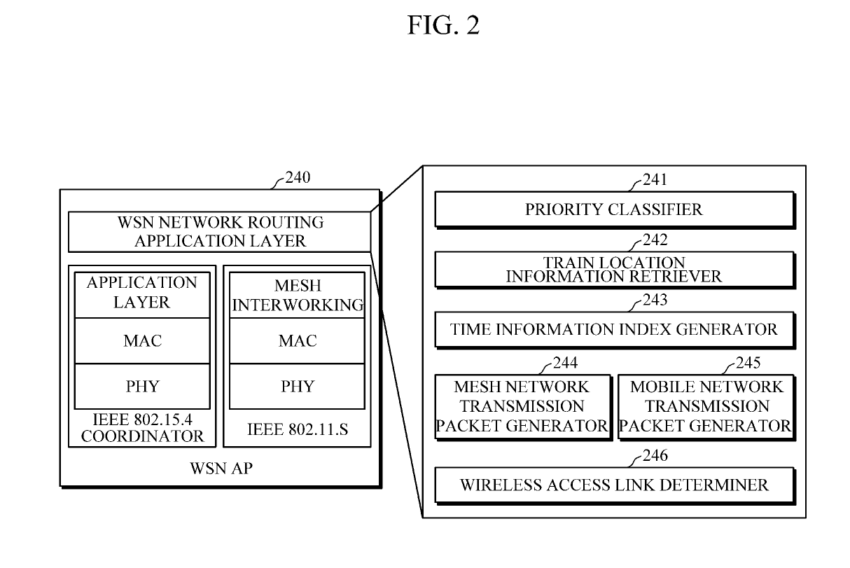

FIG. 2 is a detailed diagram illustrating Wireless Sensor Network (WSN) Access Point (AP) 240 of the apparatus 100 for distributed processing of train monitoring traffic based on a hierarchical wireless sensor network according to an exemplary embodiment.

A WSN routing application layer of the WSN AP 240 includes a priority classifier 241, a train location information retriever 242, a time information index generator 243, a mesh network transmission packet generator 244, mobile network transmission packet generator 245, and a wireless connection link determiner 246.

The priority classifier 241 classifies priorities by analyzing change characteristics based on means and variances of received sensor data. The priority classifier 241 identifies variations in sensor data based on the means and variances of the sensor data, and classifies frequently-changed sensor data as priority data, and less frequently changed data as non-priority data.

The train location information retriever 242 analyzes train locations and estimates a point in time when connection to the wireless mesh nodes 300 may be made. The train location information retriever 242 may identify a current location of a train in operation by using positioning equipment such as a GPS. Further, by comparing the location of wireless mesh nodes 300 arranged on the railway side with the current location of a train, the train location information retriever 242 may estimate a distance from a wireless mesh node 300 to be approached by a train according to a moving direction thereof, and a point in time when connection may be made. In this manner, in a high-speed train, the WSN manager 200 may enable handover from current wireless mesh nodes to subsequent wireless mesh nodes.

The time information index generator 243 adds a time information index to packets of the received sensor data. In the present disclosure, the received sensor data are not transmitted in time-sequential order, but are classified according to priorities based on change characteristics, and the classified data are transmitted to the sensor monitoring center 10 through different communication networks (a mobile communication network and a mesh network). Accordingly, the time information index generator 243 adds a time information index to the sensor data, so that the sensor data (priority data and non-priority data), transmitted to the sensor monitoring center 10 through different communication networks, may be sequentially checked and managed.

The mesh network transmission packet generator 244 generates the non-priority data, classified by the priority classifier 241, in the form of transmission packets to be transmitted to the wireless mesh nodes 300 through the mesh link. The mobile network transmission packet generator 245 generates the priority data, classified by the priority classifier 241, in the form of transmission packets to be transmitted to the sensor monitoring center 10 through a mobile communication network.

The wireless access link determiner 246 transmits the generated transmission packets to a corresponding wireless access device. The wireless access link determiner 246 transmits the mesh network transmission packets generated by the mesh network transmission pack generator 244 to the wireless mesh nodes 300 through the mesh link, and transmits the transmission packets generated by the mobile network transmission packet generator 245 to the WSN gateway 210.

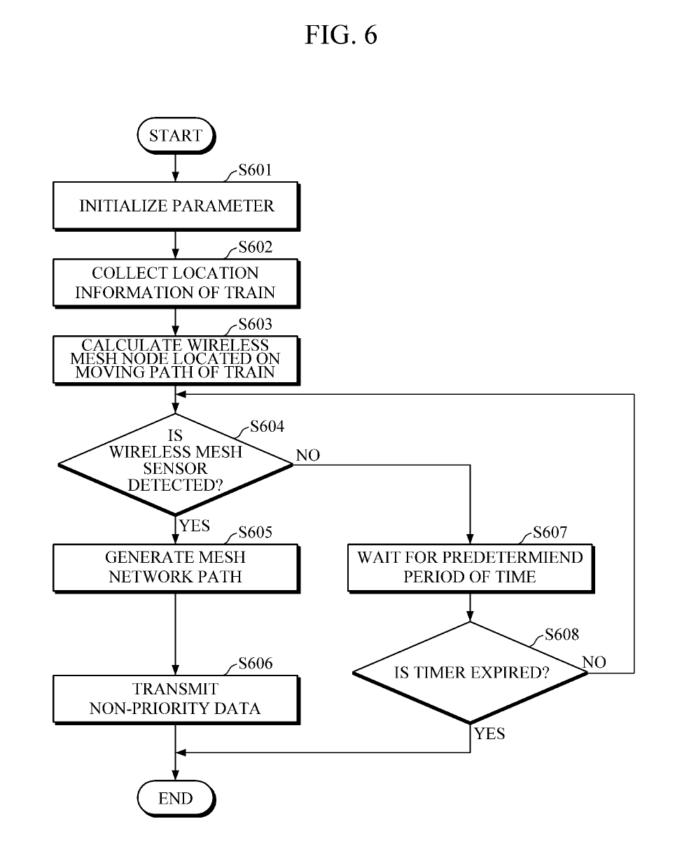

A mesh interworking component 247 of the WSN AP 240 may generate a mesh network path (link) based on location information of trains and location information of wireless sensor nodes. The WSN AP 240 may receive, in advance, from a train information database (DB), location information of the wireless mesh nodes 300 arranged on the railway side. The apparatus 100 for distributed processing of train monitoring traffic may calculate a wireless sensor node located closest to a train in a proceeding direction thereof based on the collected location information of trains, location information of the wireless mesh nodes 300, and a moving direction (or speed) of a train. Upon approaching the calculated wireless sensor node, the WSN AP 240 scans the wireless sensor node to create a mesh network link. The mesh interworking established by the WSN AP 240 will be further described later with reference to FIG. 6.

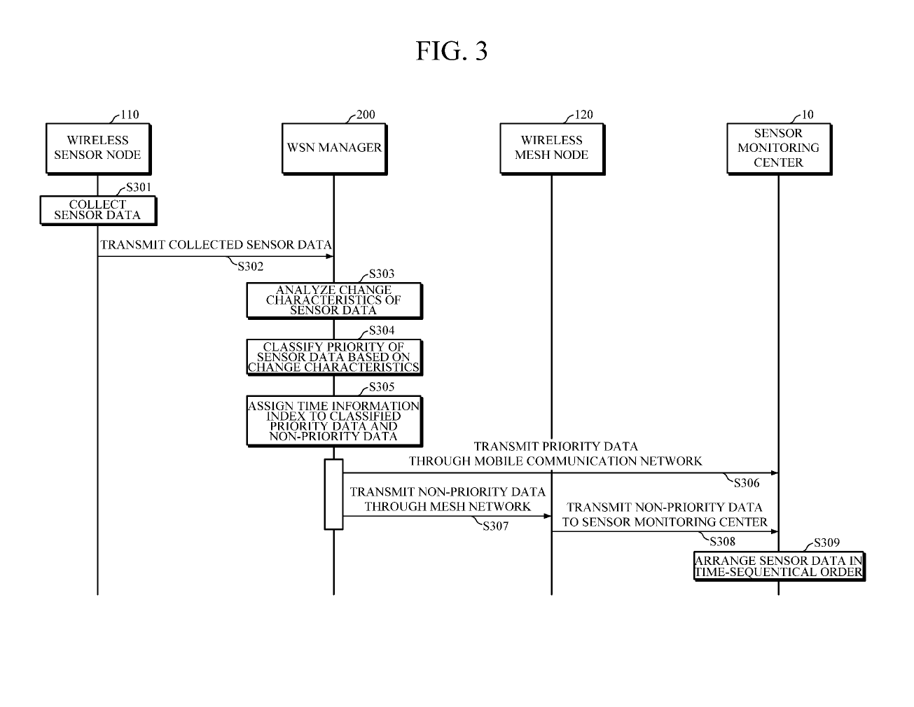

FIG. 3 is a flowchart illustrating distributed processing of train monitoring traffic which performed by using the apparatus 100 for distributed processing of train monitoring traffic based on a hierarchical wireless sensor network according to an exemplary embodiment.

Referring to FIG. 3, the wireless sensor node 110 may collect sensor data in S301 by periodically measuring temperature and vibration of bearings mounted on the axle of a railway vehicle bogie. Then, the wireless sensor node 110 transmits the detected sensor data (train state information) to a connected WSN manager 200 in S302. The wireless sensor node 110 and the WSN manager 200 may communicate with each other through a wireless sensor network, such as ZigBee communications, based on IEEE 802.15.4 standard which is a low-power, low-speed, and near-field wireless communication standard.

Upon receiving the sensor data collected from the wireless sensor node 110, the WSN manager 200 may analyze change characteristics of the received sensor data in S303 by calculating means and variances thereof. Subsequently, the WSN manager 200 may classify priorities of the sensor data into priority data and non-priority data based on the analyzed change characteristics in S304, in which change characteristics refer to variations in data values. Based on the change characteristics, the WSN manager 200 assigns a low priority to less frequently data and classifies the less frequently data as non-priority data, and assigns a high priority to more frequently data and classifies the more frequently data as priority data.

Next, the WSN manager 200 assigns a time information index to the classified priority data and non-priority data in S305. In the present disclosure, the collected sensor data are not transmitted in time-sequential order, but are classified according to priorities based on change characteristics and are transmitted to the sensor monitoring center 10 through different communication networks (a mobile telecommunication network and a mesh network). Accordingly, the WSN manager 200 adds a time information index to the sensor data, so that the sensor data (priority data and non-priority data) transmitted to the sensor monitoring center 10 through different communication networks may be sequentially checked and managed. The operation of S305 may be performed before operations S303 and S304, in which a time information index is first assigned to the sensor data, and the assigned time information index may be included in the classified priority data and non-priority data.

Subsequently, the WSN manager 200 transmits the priority data to the sensor monitoring center 10 through a mobile communication network in S306, and transmits the non-priority data to the wireless mesh node 300 through a mesh network in S307. The mesh link, which connects the WSN manager 200 and the wireless mesh node 300, may be established based on a mesh network wireless LAN standard IEEE 802.11.s. Upon receiving the non-priority data from the WSN manager 200, the wireless mesh node 300 transmits the received non-priority data to the sensor monitoring center 10 in S308. In the present disclosure, while the frequently-changed priority data are directly transmitted through a mobile communication network, the less frequently changed non-priority data are transmitted via the wireless mesh node 300, thereby enabling distributed processing of train monitoring traffic. Further, the wireless mesh nodes 300 are arranged on the railway side, rather than inside a moving train, such that a huge amount of traffic may be processed through wired communications.

The WSN manager 200 assigns a time information index to the sensor data in S305, which includes the priority and non-priority data transmitted to the sensor monitoring center 10. The sensor monitoring center 10 recovers the priority data and the non-priority data, which are transmitted through different communication paths, based on the time information index in S309.

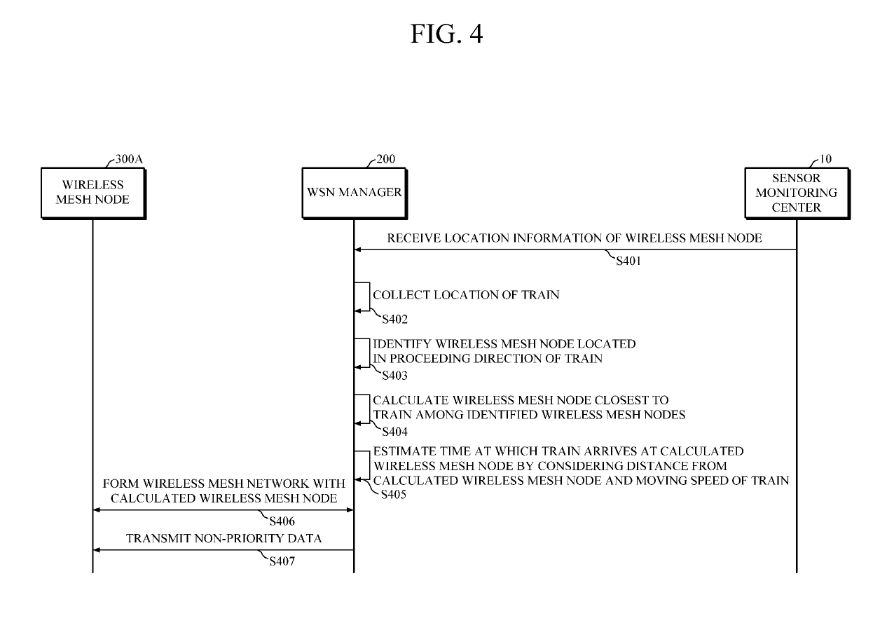

FIG. 4 is a flowchart illustrating connection to a mesh network by using the apparatus 100 for distributed processing of train monitoring traffic based on a hierarchical wireless sensor network according to an exemplary embodiment.

Referring to FIG. 4, the apparatus 100 for distributed processing train monitoring traffic based on a hierarchical wireless sensor network may rapidly establish a wireless mesh link by scanning, in advance, wireless mesh nodes 300 to be approached by a train, based on location information of a train running on a railroad and location information of one or more wireless mesh nodes 400 arranged on a railway side. In this manner, a high-speed wireless mesh network may be formed regardless of a moving speed or moving direction of a train.

The WSN manager 200 receives location information of one or more wireless mesh nodes 300 from the sensor monitoring center 10 in S401. The wireless mesh nodes 300 are spaced apart at predetermined intervals on the periphery of a railroad. Further, the location information of the wireless mesh nodes 300, including locations where the wireless mesh nodes 300 are mounted, are transmitted from the sensor monitoring center 10.

Subsequently, the WSN manager 200 collects train location information in S402. As a train constantly travels along a railroad, its locations continue to change. Accordingly, the WSN manager 200 periodically collects a current location of a train at predetermined time intervals. The WSN manager 200 may collect location information of a train by using a GPS, or may calculate a train location by using locations of stations the train has passed through or locations of the wireless mesh nodes 300, and various other methods may also be used to collect train location information. Further, the WSN manager 200 may add train speed information to the location information.

Upon collecting the location information of the wireless mesh nodes 300 and the train location information, the WSN manager 200 identifies the wireless mesh nodes 300 located in a proceeding direction of a train in S403 based on the collected location information of the wireless mesh nodes and train location information. Then, the WSN manager 200 calculates a wireless mesh node 300a, which is located closest to the train in operation, among the identified wireless mesh nodes 300 in S404. Since a plurality of wireless mesh nodes may be located in the proceeding direction of a train, the WSN manager 200 calculates the wireless mesh node 300a, located closest to the train, among the plurality of wireless mesh nodes 300 located in the proceeding direction of a train, and determines to be connected with the closest wireless mesh node 300a to form a subsequent wireless mesh network. Further, the WSN manager 200 may estimate a time at which a train arrives at the calculated wireless mesh node 300a by considering a distance from the wireless mesh node 300a and a moving speed of a train in S405.

Then, the WSN manager 200 may be connected with the calculated wireless mesh node 300a through a wireless mesh link to form a wireless mesh network in S406. In this case, the WSN manager 200 may scan in advance the calculated wireless mesh node 300a by considering the time of arrival estimated in S405, so that a wireless mesh link may be established rapidly. Once the wireless mesh network is formed by the connection with the calculated wireless mesh node 300a, the WSN manager 200 transmits the non-priority data to the calculated wireless mesh node 300a through the wireless mesh network in S407.

In this manner, the apparatus 100 for distributed processing of train monitoring traffic based on a hierarchical wireless sensor network may enable fast handover between different wireless mesh nodes (e.g., 301 to 303) according to movement of a train.

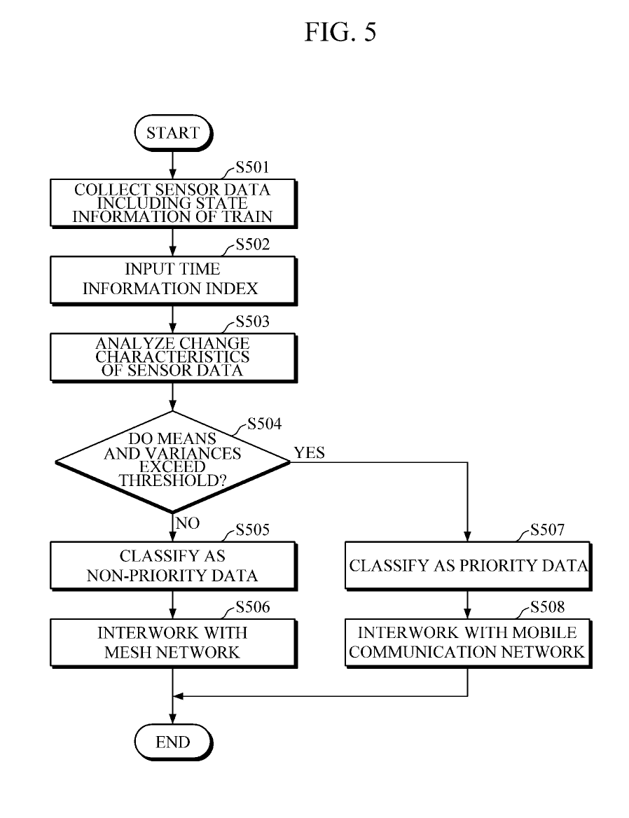

FIG. 5 is a flowchart illustrating a method of distributed processing performed by using the apparatus 100 for distributed processing of train monitoring traffic based on a hierarchical wireless sensor network according to an exemplary embodiment.

Referring to FIG. 5, the apparatus 100 for distributed processing of train monitoring traffic based on a hierarchical wireless sensor network may perform a method of distributed processing of data classified according to change characteristics by using a mesh network and a mobile communication network based on operations of a WSN network routing application layer.

First, the apparatus 100 for distributed processing of train monitoring traffic collects sensor data by periodically measuring temperature and vibration of bearings mounted on the axle of a railway vehicle bogie in S501. The apparatus 100 for distributed processing of train monitoring traffic inputs a time information index into the collected sensor data in S502. In the present disclosure, the collected sensor data are not transmitted in time-sequential order, but are classified according to priorities based on change characteristics, and the classified data are transmitted to the sensor monitoring center 10 through different communication networks (a mobile communication network and a mesh network). Accordingly, the apparatus 100 for distributed processing of train monitoring traffic adds a time information index to the sensor data, so that the sensor data (priority data and non-priority data), transmitted to the sensor monitoring center 10 through different communication networks, may be sequentially checked and managed. The operation S502 of inputting the time information index may be performed before or after the operation of classifying the sensor data.

Then, the apparatus 100 for distributed processing of train monitoring traffic analyzes change characteristics of the collected sensor data in S503. The apparatus 100 for distributed processing of train monitoring traffic calculates means and variances of the sensor data by analyzing the change characteristics. Then, the apparatus 100 for distributed processing of train monitoring traffic compares the calculated means and variances of the sensor data with a predetermined threshold to determine whether the calculated means and variances exceed the predetermined threshold in S504. If the calculated means and variances of the sensor data do not exceed the threshold, the sensor data is classified as non-priority data in S505, and then the apparatus 100 for distributed processing of train monitoring traffic transmits the non-priority data to the wireless mesh node 300 by interworking with a mesh network in S506. By contrast, if the calculated means and variances of the sensor data exceed the threshold, the sensor data is classified as priority data in S507, and then apparatus 100 for distributed processing of train monitoring traffic transmits the priority data to the sensor monitoring center 10 by interworking with a mobile communication network in S508. In this manner, the method of distributed processing of train monitoring traffic may enable distributed processing of train monitoring traffic by classifying sensor data into non-priority data and priority data and transmitting the classified non-priority data and priority data through different communication networks.

FIG. 6 is a flowchart illustrating a method of interworking with a mesh network by using the apparatus 100 for distributed processing 100 of train monitoring traffic based on a hierarchical wireless sensor network according to an exemplary embodiment.

Referring to FIG. 6, the method of interworking with a mesh network by using the apparatus 100 for distributed processing of train monitoring traffic based on a hierarchical wireless sensor network includes initializing a parameter in S601, followed by collecting train location information in S602. Since the train is in operation, train location information may be updated periodically at predetermined time intervals. Then, the apparatus 100 for distributed processing of train monitoring traffic calculates wireless sensor nodes located on a moving path of a train in S603. The apparatus 100 for distributed processing of train monitoring traffic may receive in advance location information of the wireless mesh nodes 300 located on a railway side from a train information database (DB). The apparatus 100 for distributed processing of train monitoring traffic may calculate a wireless sensor node 300, located closest to the train in a proceeding direction thereof, based on the collected speed/location information of a train, location information of the wireless mesh nodes 300 and a moving direction (or speed) of a train.

Upon calculating the wireless mesh node 300 located on a moving path of a train, the apparatus 100 for distributed processing of train monitoring traffic determines whether the calculated wireless mesh node 300 is detected in S604. The apparatus 100 for distributed processing of train monitoring traffic compares the location information of a train with a location of the calculated wireless mesh node 300, and scans the calculated wireless mesh node 300 when a train approaches the calculated wireless mesh node 300.

In response to a determination that the calculated wireless mesh node 300 is detected, the apparatus 100 for distributed processing of train monitoring traffic generates a mesh network path in S605, and transmits the non-priority data to the calculated wireless mesh node through the mesh network in S606. The non-priority data, transmitted to the connected wireless mesh node (calculated wireless mesh node), may be transmitted to the sensor monitoring center 10 through a wired communication network via the connected wireless mesh node.

In response to a determination that the calculated wireless mesh node 300 is not detected although a train approaches the calculated wireless sensor node 300, the apparatus 100 for distributed processing of train monitoring traffic wails for a predetermined period of time in S606, and determines whether a timer is expired in S607. In response to a determination that the timer is not expired, the apparatus 100 for distributed processing of train monitoring traffic redetects the wireless mesh nodes in S604. In response to a determination that the timer is expired, the apparatus 100 for distributed processing of train monitoring traffic stops transmitting packets, and retransmits the packets later. As described above, by detecting wireless mesh nodes in advance based on a moving speed and location of a train, a wireless mesh link may be established rapidly.

In the apparatus and method for distributed processing of train monitoring traffic based on a hierarchical wireless sensor network, a traffic bottleneck that may occur in the wireless sensor network may be prevented by performing distributed processing of sensor data collected by detecting train operating states through two different wireless networks.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims. Further, the above-described examples are for illustrative explanation of the present invention, and thus, the present invention is not limited thereto.

What is claimed is:

1. An apparatus for distributed processing of train monitoring traffic based on a hierarchical wireless sensor network, the apparatus comprising:
a wireless sensor node configured to generate sensor data by measuring states of a train;
a wireless mesh network (WSN) manager configured to classify the sensor data into priority data and non-priority data according to change characteristics, and to transmit the priority data to a sensor monitoring center through a wireless communication network and the non-priority data to wireless mesh nodes through a wireless mesh network; and
one or more wireless mesh nodes configured to be spaced apart at predetermined intervals on a railway side, and to transmit the non-priority data, received from the WSN manager, to the sensor monitoring center.

2. The apparatus of claim 1, wherein the WSN manager establishes a wireless sensor network inside the train, and is connected with an adjacent wireless mesh node to form a wireless mesh network.

3. The apparatus of claim 1, wherein the WSN manager calculates the change characteristics based on means and variances of the sensor data, and classifies frequently-changed sensor data as the priority data and less frequently changed data as the non-priority data.

4. The apparatus of claim 1, wherein the WSN manager determines whether the train approaches the one or more wireless mesh nodes based on location information of the train and location information of the one or more wireless mesh nodes.

5. The apparatus of claim 1, wherein the WSN identifies the one or more wireless mesh nodes located in a proceeding direction of the train based on the location information of the wireless mesh nodes and the location information of the train, calculates a wireless mesh node which is closest to the train among the identified wireless mesh nodes, and estimates a time at which the train arrives at the closest wireless mesh node by considering a distance from the calculated wireless mesh node and a moving speed of the train, so as to form the wireless mesh network with the calculated wireless mesh node.

6. The apparatus of claim 1, wherein the WSN manager inputs a time information index, including measurement time information of the sensor data, into the priority data and the non-priority data.

7. The apparatus of claim 1, wherein the one or more wireless mesh nodes and the WSN manager are connected through a mesh network.

8. The apparatus of claim 1, wherein the wireless sensor node periodically measures temperature and vibration on an axle of a railway vehicle bogie.

9. A method of distributed processing of train monitoring traffic based on a hierarchical wireless sensor network, the method comprising:
generating sensor data by periodically measuring states of a train;
classifying the sensor data into priority data and non-priority data by assigning priorities according to change characteristics;
transmitting the priority data to a sensor monitoring center through a wireless communication network; and
transmitting the non-priority data to wireless mesh nodes through a wireless mesh network.

10. The method of claim 9, wherein the classifying into the priority data and the non-priority data comprises:
calculating the change characteristics based on means and variances of the sensor data;
classifying frequently-changed sensor data as the priority data; and
classifying less frequently changed data as the non-priority data.

11. The method of claim 9, further comprising determining whether the train approaches the wireless mesh nodes based on location information of the train and location information of the one or more wireless mesh node.

12. The method of claim 1, wherein the determining whether the train approaches the wireless mesh nodes comprises:
identifying the wireless mesh nodes located in a proceeding direction of the train based on the location information of the wireless mesh nodes and the location information of the train;
calculating a wireless mesh node which is closest to the train among the identified wireless mesh nodes; and
estimating a time at which the train arrives at the closest wireless mesh node by considering a distance from the calculated wireless mesh node and a moving speed of the train.
